(19) United States
(12) Patent Application Publication
(10) Pub. No.: US 2012/0124404 A1
(43) Pub. Date: May 17, 2012

(54) COMPUTER HAVING ELECTRICITY SAVING FUNCTION

(75) Inventor: FENG XU, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 12/949,818

(22) Filed: Nov. 19, 2010

(30) Foreign Application Priority Data
Nov. 12, 2010 (CN) 201010542479.3

(51) Int. Cl. G06F 1/32

(52) U.S. Cl. 713/323

(57) ABSTRACT

A computer includes a motherboard, a capacitive sensor antenna, a capacitive approach sensor module, and a micro control unit (MCU). The capacitive sensor antenna is used to sense a capacitive signal generated from people adjacent to the computer. The capacitive approach sensor module is used to receive the capacitive signal sensed by the capacitive sensor antenna. The MCU is used to receive the capacitive signal from the capacitive approach sensor module. The MCU outputs a first control signal to a sleep control pin of the motherboard to control the motherboard to enter a sleep state in response to the capacitive signal being less than a predetermined value. The MCU outputs a second control signal to the sleep control pin to control the motherboard to exit from the sleep state in response to the capacitive signal being greater than or equal to the predetermined value.

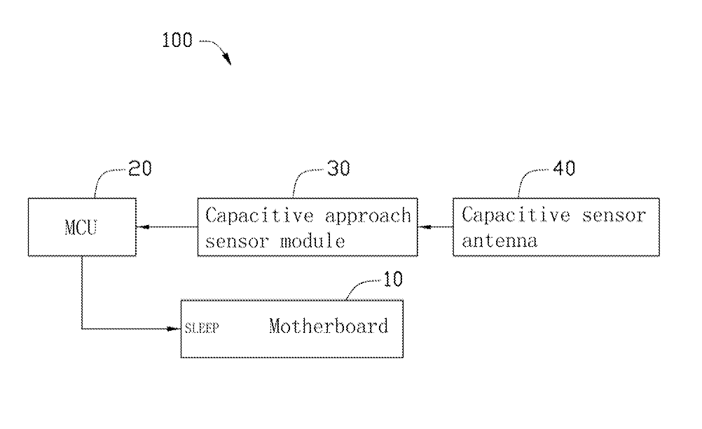

### BACKGROUND

1. Technical Field

The present disclosure relates to a computer which can save electricity.

2. Description of Related Art

Computers are widely used in our lives. Computers consume huge amounts of electricity every day in the world. A computer that can save electricity is needed to help conserve resources.

### BRIEF DESCRIPTION OF THE DRAWING

Many aspects of the present embodiments can be better understood with reference to the following drawing. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

The drawing is a block diagram of an embodiment of a computer.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the drawing, an embodiment of a computer 100 includes a motherboard 10, a micro control unit (MCU) 20, a capacitive approach sensor module 30, and a capacitive sensor antenna 40. In one embodiment, the MCU 20, the capacitive approach sensor module 30, and the capacitive sensor antenna 40 are arranged on the motherboard 10. In other embodiments, the MCU 20, the capacitive approach sensor module 30, and the capacitive sensor antenna 40 can be arranged on another place, such as mounted on inside walls of the computer 100.

The capacitive sensor antenna 40 is connected to the capacitive approach sensor module 30. The capacitive sensor antenna 40 is used to sense capacitive signals generated from people who are positioned around the capacitive sensor antenna 40. The capacitive approach sensor module 30 is used to receive the capacitive signals sensed by the capacitive sensor antenna 40. The MCU 20 is connected to the capacitive approach sensor module 30 to receive the capacitive signals output by the capacitive sensor antenna 40. The MCU 20 is also connected to a sleep control pin SLEEP of the motherboard 10. The MCU 20 can output a control signal to control the motherboard 20 to enter a sleep state or control the motherboard 20 to exit from the sleep state. For example, if the control signal is a low voltage signal, such as 0 volts (V), the motherboard 10 is controlled to enter the sleep state. If the control signal is a high voltage signal, such as 5V, the motherboard 10 is controlled to exit from the sleep state. The sleep state of the motherboard 20 is a state which can save electricity, which falls within well-known technology, and is therefore not described here.

In use, when a user using the computer leaves for another place for a while, such as going to the toilet, the capacitive sensor antenna 40 cannot sense a capacitive signal or only can sense a very weak capacitive signal. The capacitive approach sensor module 30 does not output the capacitive signal or only outputs the weak capacitive signal to the MCU 20. The MCU 20 compares the received capacitive signal with a predetermined value saved in the MCU 20, at this time, the received capacitive signal is less than the predetermined value, the MCU 20 will output the low voltage control signal to control the motherboard 10 to enter the sleep state, which can save electricity. If the user goes back to the computer 10, the capacitive sensor antenna 40 can sense a strong capacitive signal, therefore the capacitive approach sensor module 30 outputs the strong capacitive signal to the MCU 20. At this time, the received capacitive signal is greater than or equal to the predetermined value, the MCU 20 will output the high voltage control signal to control the motherboard 10 to exit from the sleep state, which allows the user to continue to work, which is very convenient.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A computer comprising:
a motherboard comprising a sleep control pin used to control the motherboard to enter a sleep state or exit from the sleep state;
a capacitive sensor antenna operable to sense a capacitive signal generated from people positioned adjacent to the computer;
a capacitive approach sensor module operable to receive the capacitive signal sensed by the capacitive sensor antenna; and
a micro control unit (MCU) operable to receive the capacitive signal from the capacitive approach sensor module;
wherein the MCU outputs a first control signal to the sleep control pin to control the motherboard to enter the sleep state in response to the capacitive signal being less than a predetermined value, the MCU outputs a second control signal to the sleep control pin to control the motherboard to exit from the sleep state in response to the capacitive signal being greater than or equal to the predetermined value.

2. The computer of claim 1, wherein the first and second control signals are respectively a low voltage signal and a high voltage signal.
